(19) United States
(12) Patent Application Publication
(10) Pub. No.: US 2013/0224336 A1
(43) Pub. Date: Aug. 29, 2013

(54) Bakery Products, in Particular Pre-Baked Breads Especially Suitable for Baking in a Toaster and method for the Production Thereof

(71) Applicants: Xavier Piezel, Randan (FR); Claire Herbin, Clermont-ferrand (FR)

(72) Inventors: Xavier Piezel, Randan (FR); Claire Herbin, Clermont-ferrand (FR)

(73) Assignee: Jaxquet Panification, Saint-beauzire (FR)

(21) Appl. No.: 13/882,062

(22) PCT Filed: Oct. 25, 2011
(86) PCT No.: PCT/EP2011/068687

§ 371 Date: Apr. 30, 2013

(30) Foreign Application Priority Data
Oct. 26, 2010 (FR) 10 58797

(51) Int. Cl. A21D 13/00

(52) U.S. Cl. CPC A21D 13/0067
USPC 426/19; 426/549

(57) ABSTRACT

The invention relates to bakery products, in particular breads, obtained from pieces of dough in the form of strips, the dimensions of which are stable after fermentation and baking. The method for the production thereof is also targeted by the invention. The aim of the invention is firstly to provide bakery products, in particular breads, having a shape and dimensions suitable for baking in a toaster, and secondly to provide an industrial process for producing these products. These bakery products are pre-baked breads in the form of pieces having dimensions (x′, y′, z′) with reference to a three-dimensional reference frame of orthogonal axes (X′, Y′, Z′), these pieces being obtained from pieces of dough having dimensions (x, y, z) with reference to a three-dimensional reference frame of orthogonal axes (X, Y, Z).

### FIELD OF THE INVENTION

The field of the invention is that of bakery products, in particular breads especially suitable for baking in toasters, and the industrial production of such products.

More precisely, the breads concerned have a shape and dimensions suitable for toasters with standard slots.

The breads according to the invention are for example breads having two large, essentially flat faces, of width (x′), length (y′) and thickness (z′) chosen so as to be able to be inserted into the slots of a standard toaster, in order to be uniformly baked and/or toasted therein.

Even more particularly, the invention relates to a pre-baked bread especially suitable for baking in a toaster and packed in standard packaging for bakery products.

The invention also relates to the production of pre-baked breads, the baking of which must be completed by any means of heating (in particular by radiation), such as toasters.

### TECHNOLOGICAL BACKGROUND

### Technical Problems

The industrial production of breads, and in particular pre-baked breads, in a standard manner comprises the phases of preparation of the dough by mixing conventional ingredients, a fermentation phase, a phase of baking in conventional bakery ovens, optionally equipped with convection means, and a packaging phase.

In the case of pre-baked breads, baking is carried out at a temperature below that normal for a baked bread, and/or for a shorter time than normal.

Industrial pre-baked bread meets the consumer requirement for the consumption of hot, fresh and crusty bread at any time.

The final baking of the pre-baked breads known to date is carried out in conventional ovens or in microwave ovens

These pre-baked breads are generally too bulky to be inserted into a toaster without slicing. In order to still further simplify the consumption of pre-baked breads, the inventors envisaged providing the consumer with units of pre-baked bread the shape and dimensions of which are suitable for finishing their baking in a standard toaster, for example a toaster with (a) slot(s) or (a) vertical or horizontal grid(s).

The difficulty then encountered in the production of such pre-baked breads presented in the form of units, consists of producing pieces of pre-baked bread the thickness of which is relatively constant and the two main surfaces of which are substantially flat, or more precisely regular without pronounced reliefs, so as to achieve uniform and regular baking in a toaster.

Failing that, the toasting of the bread shows very marked differences, for example with the more convex places being charred and the more concave places being undercooked.

Moreover, to date there are no industrial bakery products, in particular pre-baked breads, with a shape and dimensions suitable for finishing baking in a toaster.

The shape and dimensions suitable for this type of pre-baked breads could be those of a slice that can be inserted into a standard toaster, for example having (a) slot(s) or a vertical and/or horizontal grid(s).

### Objectives of the Invention

The present invention aims to satisfy at least one of the objectives listed below.
providing bakery products, in particular breads, preferably pre-baked breads especially suitable for baking in toasters, in particular toasters with (a) slot(s) or toasters with (a) vertical or horizontal grid(s);
providing bakery products, in particular breads, in the form of pieces or units having at least two substantially flat surfaces (without pronounced relief(s)), and the dimensions of which do not vary, or vary only slightly after fermentation, and at least partial baking;
providing bakery products, in particular breads, with a shape and dimensions suitable for baking in a toaster, which whilst being industrialized and therefore economic, have a high and constant organoleptic quality level;
providing bakery products, in particular breads, for example pre-baked, the baking of which is completed in a toaster, while providing uniform baking at the surface in order to retain its attractive appearance for the consumer and its good organoleptic qualities;
providing intermediate baking products, in particular pieces of dough, making it possible to produce bakery products, in particular breads, for example pre-baked, of the type of those satisfying all or some of the objectives referred to above;
providing an industrial process for the production of bakery products, in particular pre-baked breads, having a shape and dimensions suitable for a baking in a toaster;
providing an industrial process for the production of bakery products, in particular breads, in the form of units having at least two substantially flat surfaces (without pronounced relief(s)), and the dimensions of which do not vary or vary only slightly after fermentation, and at least partial baking;
providing an industrial process for the production of bakery products, in particular breads, having a shape and dimensions suitable for baking in a toaster and which correspond to the industrial norms for standardization and mass production, while maintaining a high and constant organoleptic quality level;
providing an industrial process for the production of bakery products, in particular breads, making it possible to obtain a bread, for example a pre-baked bread, the baking of which is completed in a toaster while offering uniform baking at the surface in order to retain its attractive appearance for the consumer and its good organoleptic qualities;
providing an industrial process for the production of bakery products, in particular breads, whilst limiting production costs so far as possible.

### BRIEF DESCRIPTION OF THE INVENTION

These objectives, among others, are achieved by the present invention which relates firstly to bakery products, in particular breads, preferably pre-baked, in the form of pieces (or units) having dimensions (x′, y′, z′) with reference to a three-dimensional reference frame of orthogonal axes (X′, Y′, Z′), these pieces being obtained from pieces of dough having dimensions (x, y, z) with reference to a three-dimensional reference frame of orthogonal axes (X, Y, Z) characterized in that they have recessed marks on the top surface of the product and characterized by at least one of the following features:
i. x′≧0.8·(x); preferably x′≧0.9·(x); and,
   even more preferably x′≧0.95·(x);
ii. y′≧0.8·(y); preferably y′≧0.9·(y); and,
   even more preferably y′≧0.95·(y);
      x′, y′ being the greatest dimensions of the breads along the axes X′ and Y′ respectively;
      x, y being the greatest dimensions of the pieces of dough 1 along the axes X and Y respectively;
iii. the difference (D in %) between the maximum mean height (max mean z′) and the minimum mean height (min mean z′) of the top surface of the breads:

D=[(max mean z′−min mean z′)/max mean z′]·100
is less than or equal to 30, preferably 25, and,
even more preferably is comprised between 15 and 25;

max mean z′ is determined as follows: (z′) is measured, for example with a vernier calliper, for at least six points among the highest in the bread. These points can be equidistant from the closest recessed marks.

min mean z′ is determined as follows: (z′) is measured, for example with a vernier calliper, for at least six points among the lowest in the bread. These points can be equidistant from the edges of the bread.

These breads are of constant thickness and their dimensions (x′, y′, z′) are such that they can be inserted in particular into all types of standard toasters on the market.

In a preferred embodiment, these breads have two substantially flat main surfaces, the regularity of relief of their two main surfaces ensuring uniform heating, and therefore preventing charred areas and undercooking.

In another of its aspects, the invention relates to pieces of dough from which bakery products are capable of being obtained, in particular, preferably pre-baked breads, these pieces of dough being in the form of pieces (or units) having dimensions (x, y, z) with reference to a three-dimensional reference frame of orthogonal axes (X, Y, Z), characterized in that they have recessed marks distributed uniformly over the entire top surface of the piece of dough, so that the maximum contiguous (or continuous) surface area of the top surface of the piece of dough 1, in a plane (X, Y), is less than 25%, preferably less than or equal to 20%, or even better comprised between 15 and 20% of the total surface area of the top surface of the product, in a plane (X, Y), in that the depth (p) of at least some of the recessed marks 2 corresponds to at least, preferably in increasing order, 80, 90, 92% of the dimension (z) of the piece of dough 1 in question, (z) and (p) being measured on the same axis, and, more preferably (p) is equal to 98%+/−1% of (z), and in that the recessed marks 2 are at least partially filled with an anti-adhesion production agent.

In another of its aspects, the invention relates to a method for producing bakery products, in particular breads, characterized in that it essentially consists of:
—a—preparing a dough,
—b—optionally, bulk fermentation (initial fermentation) of said dough,
—c—transforming the dough into strips of dough of width (x),
—d—providing recessed marks in at least the top surface of the strips of dough, the depth (p) of at least some of the recessed marks corresponding to at least, preferably in increasing order, 80, 90, 92% of the thickness (z) of the strip of pieces of dough in question, (z) and (p) being measured on the same axis, and, more preferably, (p) is equal to 98%+/−1% of (z), the recessed marks being at least partially filled with an anti-adhesion production agent,
—e—optionally, completing the filling of the recessed marks in the pieces of dough with the anti-adhesion agent,
—f—cutting the strips of dough transversally in order to obtain pieces of dough of given length (y),
—g—fermenting the pieces of dough,
—h—baking the pieces of dough,
—i—optionally, cooling the baked breads,
—j—optionally, packaging the cooled baked breads.

It is to the inventors' credit to have designed and carried out this step —d— of providing recessed marks in particular to ensure a dimensional stability for the pieces of dough, after fermentation and baking.

Preferably, this marking step —d— occurs before the fermentation —g—.

The method according to the invention is all the more advantageous as it is simple and inexpensive to implement and ensures a high organoleptic and aesthetic quality to the breads that it makes it possible to produce.

### DETAILED DESCRIPTION OF THE INVENTION

Definitions

The terminology used in the present disclosure is set out via the following definitions which are all non-limitative examples:

“Bakery products” denotes breads of any type, with or without crust, sandwich loaves, white breads, black breads, speciality breads containing cereals of different types, and more generally all products obtained by fermentation and baking of a dough based on flour of any cereal (e.g. wheat), water, sugar, yeast, fats, among other things.

“Pre-baked bread” denotes a bread pre-baked at a temperature 10 to 20% below the usual temperature of baking ovens, and for a shorter baking time than normal, but sufficient to allow the transformation of the centre of the piece of dough to bread. A pre-baked bread can for example be baked for a period of 5 to 15 minutes, at a temperature comprised between 180 and 230° C. For example, a pre-baked bread corresponds to 80%+/−10% baking of the bread.

“Bread” denotes all types of breads including in particular French bread or equivalent, obtained from very hydrated dough, with few ingredients and having a tendency to stick. It can also denote coloured breads of the granary-bread type, black bread, etc. with more ingredients.

“Piece of dough” denotes a unit or a piece of bread dough intended to be baked in order to produce a unit or a piece of bread of similar shape.

“Toaster” denotes any standard toaster, in particular a toaster with (a) slot(s) or toaster with (a) vertical and/or horizontal grid(s), making it possible toast slices of food, in particular bread (toasts). A toaster generally uses the properties of infrared radiation to heat a piece of bread (joule effect).

“Maximum contiguous (or continuous) surface” denotes the largest surface area Smax of uniform appearance and regular contour existing according to the projection (X′, Y′) in the case of a loaf and according to the projection (X, Y) in the case of a piece of dough, of the top surface of the loaf or of the piece of dough according to the invention. The dimensions of this projection are (x′, y′) in the case of a loaf and (x, y) in the case of a piece of dough. In this projection, Smax has a uniform appearance without recessed marks and is delimited by the recessed marks and/or the edges of the projection, under conditions according to which all or some of the recessed marks (preferably all) extend from an edge parallel to X′ or X of the projection beyond the median axis parallel to the axis Y′ or Y, and/or from an edge parallel to Y′ or Y of the projection beyond the median axis parallel to the axis X′ or X. The circumference of Smax is regular with no crenellations, indentations or broken lines.

### DETAILED DESCRIPTION OF THE INVENTION

The Bakery Products: the (Pre-)Baked Breads and Pieces of Dough

The bakery products according to the invention comprise pre-baked breads having dimensions (x′, y′, z′) such that they can be inserted into and heated in toasters with standard slots.

These are true unit pieces of breads, not sliced. They can have a general shape of a polyhedron, disc, or an ovoid or elliptical shape in front view. These are for example muffins or buns. Preferably, these (pre-)baked breads have a general parallelipipedic shape with rounded edges.

According to a variant, the shape can be a parallelipiped the dimensions x′ and y′ of which can be equal.

Advantageously, these bakery products, in particular these preferably pre-baked breads, are in the form of pieces (or units) having dimensions (x′, y′, z′) with reference to a three-dimensional reference frame of orthogonal axes (X′, Y′, Z′), these pieces being obtained from pieces of dough having dimensions (x, y, z) with reference to a three-dimensional reference frame of orthogonal axes (X, Y, Z) characterized in that the recessed marks are distributed uniformly over the entire top surface of the product, so that the maximum contiguous (or continuous) surface area (Smax) of the top surface of the product, in a plane (X′, Y′), is less than 25%, preferably less than or equal to 20%, or even better comprised between 15 and 20% of the total surface area of the top surface of the product, in a plane (X′, Y′).

According to a remarkable characteristic of the invention, the recessed marks are chosen from longitudinal, transversal, diagonal, curved, straight grooves, grooves in broken lines, from combinations of these grooves and/or from the recessed marks made for example with a punch.

The pieces of dough are intermediate products of the production of bakery products, in particular breads, preferably pre-baked, according to the invention.

These (pre-)baked breads and these pieces of dough can be obtained in particular by the method according to the invention.

They are described below as examples, with reference to the attached Figures.

### DESCRIPTION OF THE FIGURES

FIG. 1 is a perspective view of a piece of dough (x, y, z) obtained at the end of step —f— or —g— of the method.

FIG. 2 is a longitudinal cross-section along line II-II in FIG. 1.

FIG. 3 is a view of the strips of dough of width (x) of the step —c—.

FIG. 4 is a diagrammatic top view of the unit pieces of dough (x, y, z) after marking in step —d— and transversal cutting in step —f—.

FIG. 5 COMP shows a counter example of the invention (negative control).

FIG. 5′ COMP is a projection in a plane X′,Y′ of the bread in FIG. 5COMP to show the maximum contiguous surface area of the top surface of this bread.

FIGS. 6 to 10 are perspective top views showing the models or patterns for marking the pieces of dough (x, y, z) produced in step —d—.

FIG. 6′ is a projection in a plane X′,Y′ of the bread in FIG. 6 to show the maximum contiguous surface area of the top surface of this bread.

FIGS. 11A&B and 12A&B are side and top views respectively
on the left, of a bread marked according to the invention having dimensions (x′ₐ, y′ₐ, z′ₐ) obtained from a piece of dough having dimensions (xₐ, yₐ, zₐ), and
on the right, of unmarked bread having dimensions (x′_{b}, y′_{b}, z′_{b}) obtained from a piece of dough having dimensions (x_{b}, y_{b}, z_{b}).

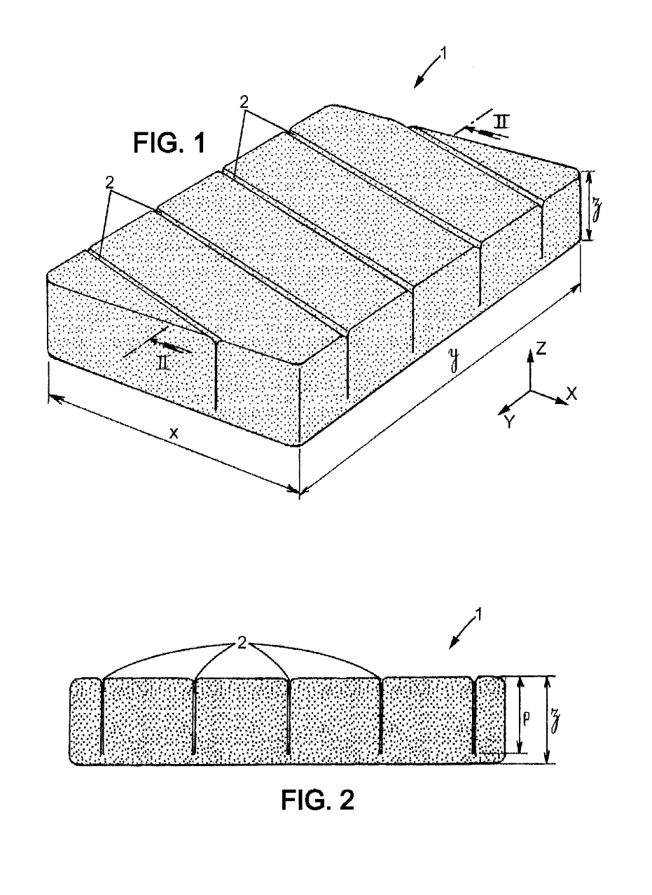

The piece of dough 1 in FIGS. 1 and 2 is a block of dough with a substantially parallelipipedic shape of width (x), length (y) and height/thickness (z), with reference to the axes X, Y, Z.

It comprises recessed marks 2 with a depth (p)=98% (FIG. 2).

For example, and in increasing order of preference:
(x) comprised between 2 and 15 cm, preferably between 4 and 12 cm and even more preferably, between 6 and 10 cm, for example 8 cm;
(y) comprised between 5 and 20 cm, preferably between 8 and 15 cm and even more preferably, between 11 and 14 cm, for example 13 cm;
(z) comprised between 0.5 and 5 cm, preferably between 1 and 4 cm, and even more preferably, between 2 and 3 cm.

The dimensions (x, y, z) given here as examples correspond to the greatest dimensions of the units of pieces of dough; (x) could in particular be equal to (y) (square surfaces).

The piece of dough 1 in FIGS. 1 and 2 corresponds to the bread in FIG. 6.

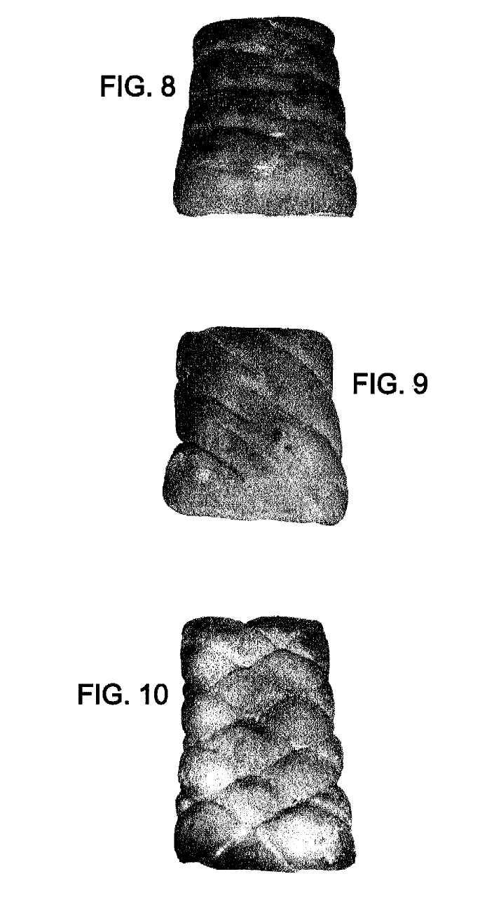

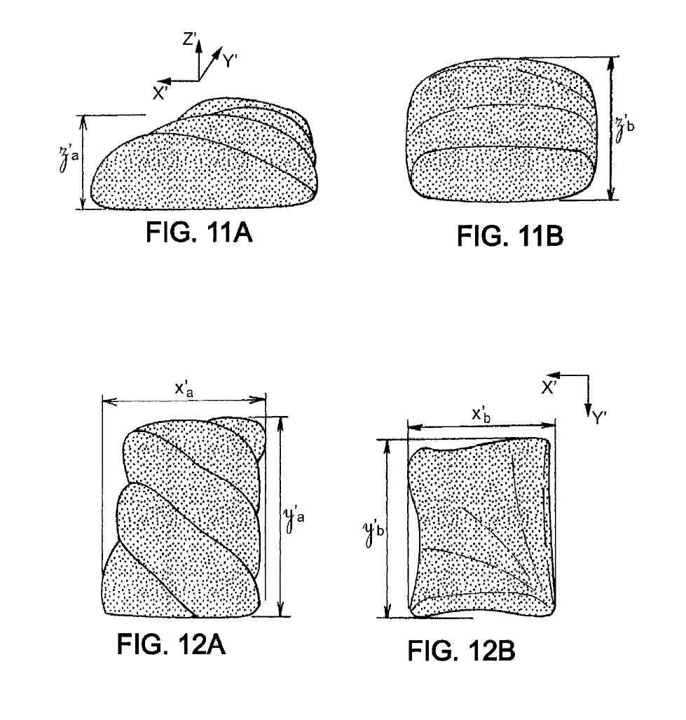

As FIGS. 6 to 10 show by way of example, the patterns for producing recessed marks 2 can be straight, continuous, parallel and diagonal grooves (FIG. 6), recessed marks cylindrical in shape made, for example, with a punch, continuous, curved and longitudinal grooves (FIG. 7), straight, discontinuous, parallel transversal (FIG. 8) or diagonal (FIG. 9) grooves, straight, discontinuous, parallel diagonal and intersecting grooves (FIG. 10).

According to the invention, these recessed marks 2 should be distributed uniformly over the entire top surface of the pieces of dough.

In the example shown in FIGS. 6 and 6′, the maximum contiguous (or continuous) surface area Smax of the top surface of the bread, in a plane (x′, y′), is equal to 15% of the total surface area (x′, y′) of the top surface of the bread (see FIG. 6′).

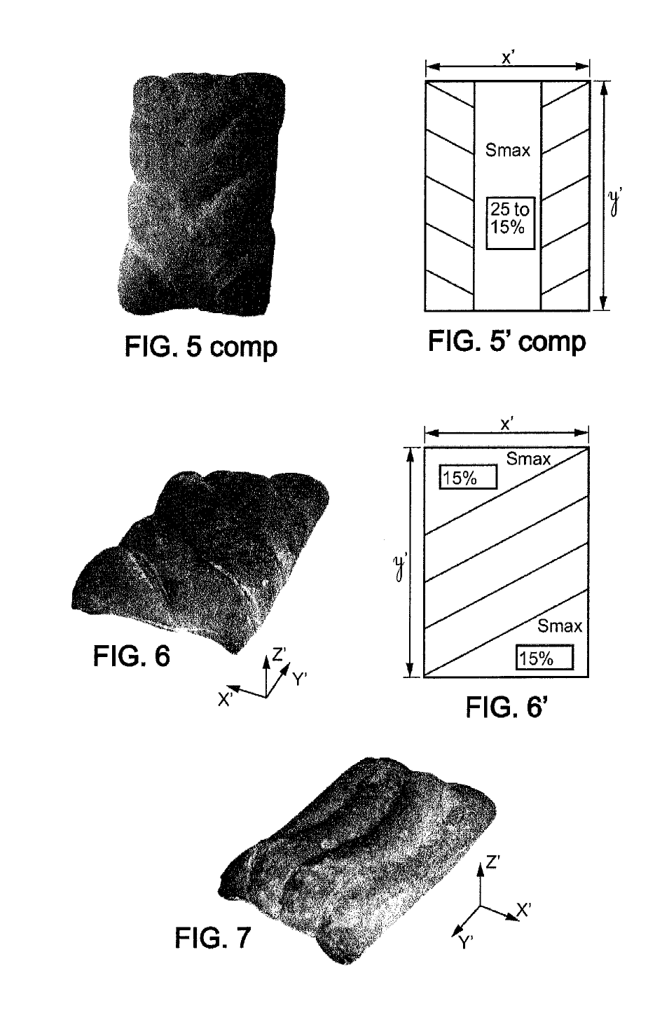

FIGS. 5COMP and 5′COMP show a counter example in which the marking is not uniform. There is no recessed mark on a central strip Smax of the top surface over the entire length (y′)—see FIG. 5′COMP-. This strip Smax corresponds to the maximum contiguous (or continuous) surface area of the top surface of the bread. None of the interstitial surfaces between the parallel diagonal marks 2 in the two longitudinal edges of the bread, forms part of this maximum contiguous surface, as in such a case the circumference would have indentations and/or crenulations.

The breads in FIGS. 6 to 10 are e.g. pre-baked breads the baking of which can be completed in a standard toaster on the market, thanks to their suitable dimensions and the surface regularity (not at all, or only slightly, pronounced reliefs) of their top and bottom surfaces.

Thus, the infrared radiation emitted by the toaster is effective and bakes or toasts said bread without burning it in places, while undercooking it in other places.

The breads according to the invention having dimensions (x′, y′, z′) obtained from pieces of dough 1 having dimensions (x, y, z) are such that the difference between the dimensions (x′, y′, z′) and the dimensions (x, y, z) is less than or equal to 20%, preferably 10% and even more preferably 5%.

Moreover, as shown by FIGS. 11 A&B and 12A&B, for the same weight per unit area and the same dimensions (x, y, z) of the piece of dough 1, the method according to the invention allows a stabilization of the dimensions of the finished product, i.e. of the baked bread, in particular in the thickness (z, z′).

FIGS. 11A&B show that the pre-baked bread obtained according to the invention (on the left) has a thickness (z′ₐ) less than that (z′_{b}) of the control bread on the right. In fact, the convexity of the bread according to the invention on the left, is less than that of the control bread on the right.

In the same way, FIGS. 12A&B show that the dimensions of width (x′ₐ) and length (y′ₐ) of the bread according to the invention on the left, are greater than those (x′_{b}, y′_{b}) of the control bread on the right.

This smaller dimensional shrinking on baking is reflected, for example, in the case of the breads in FIGS. 11A&B and 12A&B, in the fact that the difference between the dimensions (x, y, z) of the piece of dough 1 and (x′, y′, z′) of the pre-baked bread, is respectively 10%, 5% and 5% in the case of the bread according to the invention on the left, and 30%, 25% and 25% in the case of the control bread on the right.

The Method

The method according to the invention makes it possible to have units of bread (e.g. pieces of a general parallelipipedic shape) to bake in a toaster, the dimensions of which (x′, y′, z′) are suitable for this toaster of whatever type it may be, in particular with (a) slot(s), and the surfaces of which have a flatness or as regular a relief as possible, to avoid marked differences in terms of toasting intensity. They may be breads, for example, of a substantially parallelipipedic shape, with a thickness comprised between 10 and 50 mm, preferably between 15 and 40 mm, and more preferably between 25 and 30 mm. These breads are obtained by an industrial method in which the pieces of dough are provided with a recessed mark (stamping) over at least 80% of the thickness of said pieces of dough (depth (p)). It is also ensured that the recessed marks applied to the pieces of dough do not close up again. For this purpose, an anti-adhesion agent, preferably flour, is applied to said pieces of dough before stamping.

It should be noted that the order of the steps —a—,—b—,—c—,—d—,—e—,—f—,—g—,—h—,—i—,—j— corresponds to a preferred method of the invention, without however departing from the variants in which this order would be modified, for example, all or some of the recessed marks —d— could be applied before and/or after the fermentation —g—, and/or the transversal cutting —f— of the strips of dough into pieces of dough could occur before the marking —d—.

Step —a—: Kneading

This step of preparation of the dough comprises the operation of mixing the conventional ingredients, namely the flour, water, sugar, yeast, fats and breadmaking additives. This mixing is continued by kneading.

Preferably, the composition of the dough is as follows (in parts by weight):

| | | |
|---|---|---|
| flour | 100 | |
| water | 30-80 | preferably 40-70 |
| yeast | 0.5-8 | preferably 1-5 |
| fats | 0-15 | preferably 0-8 |
| salt | 0-5 | preferably 0-2.5 |
| additives | 0-10 | preferably 0-5 |
| sugar | 0-10 | preferably 0-5 |

The dough is kneaded in a conventional bakery bread-kneading machine of the spiral kneader type or equivalent, according to a conventional kneading schedule, for example: 2-6 minutes at a slow speed, then 2-10 minutes at a fast speed.

For conventional doughs, the temperature induced in the centre of the dough at the end of kneading is comprised for example, preferably in increasing order, between 20 and 35° C., 22 and 32° C., 25° C.+/−1° C.

Step —b—: Initial Fermentation

This process can be suitable for doughs having undergone bulk fermentation, called initial fermentation, for a period comprised between 20 and 120 minutes, preferably 50 minutes+/−10minutes.

This optional initial fermentation step —b— is advantageously carried out in a temperature-controlled (15 to 40° C., preferably 20 to 35° C.) and humidity-controlled (60 to 99% ERH, preferably 60 to 80% ERH) enclosure.

Step —c—: Transformation

This step —c— of transformation of the dough into strips 3 of dough, comprises sub-steps of extrusion —c1—, sheeting —c2— and longitudinal cutting —c3—.
The extrusion sub-step —c1— consists of passing the dough through an extruder, so as to obtain a dough rope of given width, for example 50 cm, depending on the yield of the extrusion line.
The sheeting sub-step —c2— makes it possible to reduce the thickness of the rope to the given thickness z of the strip of dough.
The longitudinal cutting sub-step —c3— makes it possible to transform the strip of sheeted dough to the thickness z, in strips 3 of dough with a width of x.

Step —d—: Marking

The provision of recessed marks —d— in the top surface of the strips 3 of dough is carried out by means of one or more appropriate tool(s) (stamping tools), preferably constituted by tools with non-cutting blades, the thickness of which is comprised between 1 and 5 mm, preferably between 2 and 3 mm.

The depth (p) of the recessed marks 2 is advantageously comprised between 92 and 99% of the total thickness (z) of the strip of dough in question. According to a particularly preferred embodiment, p=98% of (z).

According to a remarkable characteristic of the invention, the recessed marks 2 produced in step —d— are distributed uniformly over the entire top surface of the strips 3 of dough. This means, for example, according to the invention, that the maximum contiguous (or continuous) surface area Smax of the top surface of the piece of dough 1, in a plane (X, Y), is less than 25%, preferably less than or equal to 20%, or even better comprised between 15 and 20% of the total surface area (x, y) of the top surface of the piece of dough. This maximum contiguous (or continuous) surface area Smax is for example the one having a regular periphery or shape (with no crenellations/indentations/broken lines). Preferably, the recessed marks 2 produced in step —d— have such shapes and are presented in quantities such that:
i. x′≧0.8·(x); preferably x′≧0.9·(x); and,
   even more preferably x′≧0.95·(x);
ii. y′≧0.8·(y); preferably y′≧0.9·(y); and,
   even more preferably y′≧0.95·(y);
      x′, y′ being the greatest dimensions of the breads along the axes X′ and Y′ respectively;
      x, y being the greatest dimensions of the pieces of dough (1) along the axes X and Y respectively;
iii. the difference (D in %) between the maximum mean height (max mean z′) and
   the minimum mean height (min mean z′) of the top surface of the breads:
      D=[(max mean z′−min mean z′)/max mean z′]·100
      is less than or equal to 30, preferably 25, and,
      even more preferably is comprised between 15 and 25;

The dimensions (x′, y′, z′) of the breads are such that the latter can be inserted into and heated in toasters with standard slots.

According to a particular arrangement of the invention, the recessed marks produced in step —d— are chosen from longitudinal, transversal, diagonal, curved, straight grooves, grooves in broken lines, from the combinations of these grooves and/or from the recessed marks made for example with a punch.

Anti-Adhesion Treatment

During at least one of steps —a—,—b—, c—,—d—, the dough and/or the pieces of dough 1 are subjected to an anti-adhesion treatment, preferably a flouring which is carried out over the entire surface. This flouring must be sufficient to limit the phenomenon of adhesion or “sticking”, but above all so that the anti-adhesion e.g. flour-based agent fills, at least in part, the recessed marks produced in step —d—.

Step —e—: Additional Filling of the Recessed Marks (2)

According to an optional variant, the anti-adhesion agent, namely e.g. the residual flour present on the piece of dough, in particular on the top surface of the piece of dough, can be brushed to increase the filling of the slits or marks.

Step —f—: Transversal Cutting

The marked strips 3 of dough are cut transversally in order to obtain pieces of dough 1 with a length of (y). The pieces of dough 1 are preferably of a general parallelipipedic shape, having dimensions (x, y, z).

The pieces of dough obtained have for example a weight comprised between 30 and 150 g, preferably between 70 and 90 g.

Step —g—: Fermentation

The pieces of dough 1 thus shaped are arranged on baking and/or cooking supports so that the final fermentation takes place over a period comprised, for example, between 1 and 4 hours, preferably between 1 and 2 hours, for example 1 hour 30 minutes. This fermentation is advantageously carried out in a temperature-controlled (15 to 45° C., preferably 20 to 35° C.) and humidity-controlled (60 to 99% ERH, preferably 70 to 95% ERH) enclosure.

Step —h—: Baking

The pieces of dough 1 are then placed in an oven for baking —h—, preferably in a stone deck oven, and at a temperature comprised between 180 and 280° C., preferably between 200 and 260° C. (top and bottom temperature), for 3 to 45 minutes, preferably 5 to 25 minutes, and even more preferably 10 to 20 minutes.

The baking carried out is preferably a pre-baking representing 80%+/−10% of the total baking normally necessary to have baked bread.

Step —i—

Optionally, but nevertheless preferably, the baked or pre-baked breads are cooled, for example using a system suitable for this purpose, such as a cooling tower or similar. By way of example, for breads of 60 g, the cooling time can be of the order of 40 minutes +/−5 minutes.

Step —j— Packaging

The breads (e.g. pre-baked) are packaged in standard manner in sealed food containers (e.g. plastic bags).

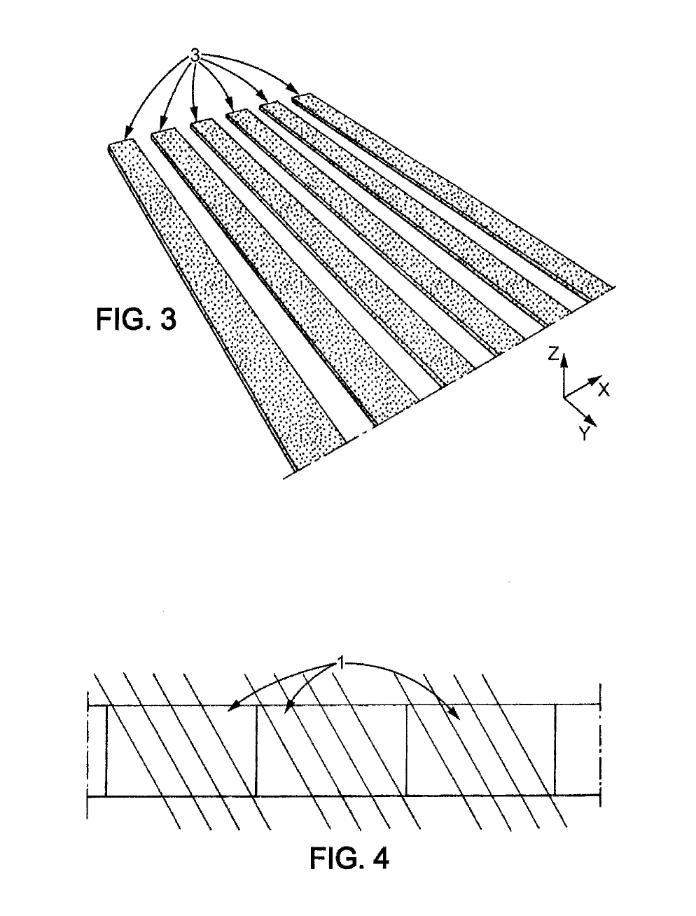

Apart from the pieces of dough 1 according to FIGS. 1 and 2, or the breads according to FIGS. 6 to 10, the method according to the invention involves intermediate products which are the longitudinal strips 3 of dough shown in FIG. 3, of width (x) and thickness (z).

FIG. 4 shows these same strips 3 of dough cut into units of pieces of dough 1 with a length of (y).

The following example makes it possible to better understand the invention in terms of method and in terms of product, and also makes it possible to highlight all the advantages and variants of implementation or realization.

### EXAMPLE

The composition of the dough is as follows:

| | | |
|---|---|---|
| Wheat flour T55 | 25 | kg |
| Water (tap water) | 16 | L |
| Compressed yeast | 300 | g |
| Rapeseed oil | 250 | g |
| Salt | 450 | g |
| Gluten | 125 | g |
| Calcium propionate preservative | 100 | g |
| Ascorbic acid | 2 | mg |
| Deactivated yeast | 125 | g |
| Emulsifier E471 | 125 | g |
| Emulsifer E472 | 50 | g |

Step —a—

The dough is kneaded in a ‘spiral’—type kneader according to a conventional kneading schedule: 3 minutes at a slow speed (40 rpm) then 7 minutes at a fast speed (80 rpm). The temperature of the water was calculated as a function of the temperature of the ingredients and that of the baking room in order to obtain a dough having, at the end of kneading, a temperature of 25° C.

Step —b—

The dough was subjected to a first bulk fermentation more commonly called initial fermentation. The latter lasted 60 minutes at a temperature of 25° C. The initial fermentation phase was carried out in an enclosure at an ambient temperature of 25° C. The dough was covered with a plastic film in order to limit any drying-out phenomenon.

Sub-Step —c1—

The dough was calibrated using a machine called an extruder, the latter is constituted by belts and rollers. The strip had a width of 40 cm and a thickness of approximately 3 cm.

Throughout the process and until it is deposited on a couche, the strip of dough is continuously transported on a series of plastic belt or drag conveyors.

A first (anti-adhesion) flouring is applied to the top of the dough in order to remedy excess stickiness.

Sub-Step —c2—

The dough is then sheeted using a series of rollers in order to obtain a strip of approximately 7 mm thickness (z). A second flouring is then carried out, this time of both sides of the dough before subjecting it to the cutting operations.

Sub-Step —c3—

Firstly, the strip of dough is cut in the longitudinal direction by a system of sharp discs mounted on the same spindle. The excess dough (trimmings) is removed and recycled in bins situated under the machine. In this example, six strips have been cut to the following dimension: 66 mm in width (x).

After longitudinal cutting, each strip was removed using a “Polycord” system in order to avoid any readhesion effect in the remainder of the process.

Step —d—

Manual stamping was applied to each strip 3 using a stainless steel tool comprising a flat blade 8 cm long and 5 mm thick. The markings 2 were provided in the diagonal direction of the strip complying with an angle of approximately 45° to a depth (p) of 6.8 mm i.e. approximately 97% of the total thickness (z) of the strip. Each stamping was separated by a distance of approximately 4 cm.

Step —f—

The 6 strips 3 are then cut transversally using a sharp guillotine making it possible to obtain the final product with the desired dimensions and weight: length (y):120 mm and weight: 75 g.

Step —g—

Each product was collected manually then placed on a textile fabric commonly called a baker's couche. The latter serves as a support for the product during fermentation. Each couche was previously floured with durum wheat flour. The products were placed in an oven set to a temperature of 28° C. and 85% humidity for a duration of 75 minutes. This fermentation corresponds to an increase in volume of approximately 2.5 times the starting volume.

Step —h—

The pieces of dough 1 thus fermented were directly deposited on the floor of the oven (deck oven with a refractory cement floor). Steam was injected before and after deposition, in order to allow complete saturation of the atmosphere in the oven. The baking temperature and time are as follows: 230° C. (top and bottom temperature) for 14 minutes.

Step —i—

After unloading of the products using an oven peel, the breads cooled on stainless steel racks for a duration of 60 minutes at ambient temperature (approximately 25° C.).

Step —j—

The breads were finally packaged manually in plastic bags, themselves hermetically sealed using a heat-sealing system.

1. Bakery products, in particular breads, preferably pre-baked, in the form of pieces having dimensions (x′, y′, z′) with reference to a three-dimensional reference frame of orthogonal axes (X′, Y′, Z′), these pieces being obtained from pieces of dough having dimensions (x, y, z) with reference to a three-dimensional reference frame of orthogonal axes (X, Y, Z) characterized in that they have recessed marks distributed over the top surface of the product and in that they have at least one of the following features:
i x′≧0.8·(x); preferably x′≧0.9·(x); and,
even more preferably x′≧0.95·(x);
ii y′≧0.8·(y); preferably y′≧0.9·(y); and,
even more preferably y′≧0.95·(y);
x′, y′ being respectively the greatest dimensions of the breads along the axes X′ and Y′;
x, y being respectively the greatest dimensions of the pieces of dough along the axes X and Y;
iii the difference (D in %) between the maximum mean height (max mean z′) and the minimum mean height (min mean z′) of the top surface of the breads:
D=[(max mean z′−min mean z′)/max mean z′]·100
is less than or equal to 30, preferably 25, and,
even more preferably is comprised between 15 and 25.

2. The products according to claim 1, wherein the recessed marks are distributed uniformly over the entire top surface of the product, so that the maximum contiguous (or continuous) surface area of the top surface of the product, in a plane (X′, Y′), is less than 25%, preferably less than or equal to 20%, or even better comprised between 15 and 20% of the total surface area of the top surface of the product, in a plane (X′, Y′).

3. The products according to claim 1, wherein the dimensions (x′, y′, z′) of the breads are such that the latter can be inserted into and heated in toasters with standard slots.

4. The products according to claim 1, wherein the recessed marks are chosen from the longitudinal, transversal, diagonal, curved, straight grooves, grooves in broken lines, from the combinations of these grooves and/or from the recessed marks made with a punch.

5. The products according to claim 1, wherein they have a general shape of a polyhedron, disc, or an oval or elliptical shape in front view, preferably, these (pre-)baked breads have a general parallelipipedic shape with rounded edges.

6. Pieces of dough from which bakery products are capable of being obtained, in particular, preferably pre-baked breads, these pieces of dough being in the form of pieces (or units) having dimensions (x, y, z) with reference to a three-dimensional reference frame of orthogonal axes (X, Y, Z), wherein they have recessed marks distributed uniformly over the entire top surface of the piece of dough, so that the maximum contiguous (or continuous) surface area of the top surface of the piece of dough 1, in a plane (X, Y), is less than 25%, preferably less than or equal to 20%, or even better comprised between 15 and 20% of the total surface area of the top surface of the product, in a plane (X, Y), in that the depth (p) of at least some of the recessed marks corresponds to at least, preferably in increasing order, 80, 90, 92% of the dimension (z) of the piece of dough 1 in question, (z) and (p) being measured on the same axis, and, more preferably (p) is equal to 98%+/−1 of (z),
and in that the recessed marks are at least partially filled with an anti-adhesion production agent.

7. A method for producing bakery products, in particular breads, preferably pre-baked, wherein it essentially consists of:
—a— preparing a dough,
—b— optionally, bulk fermentation (initial fermentation) of said dough,
—c— transforming the dough into strips of dough of width (x),
—d— providing recessed marks in at least the top surface of the strips of dough, the depth (p) of at least some of the recessed marks corresponding to at least, preferably in increasing order, 80, 90, 92% of the thickness (z) of the strip of dough in question, (z) and (p) being measured on the same axis, and, more preferably (p) is equal to 98%+/−1% of (z),
the recessed marks being at least partially filled with an anti-adhesion production agent,
—e— optionally, completing the filling of the recessed marks of the strips of dough with the anti-adhesion agent,
—f— cutting the strips of dough transversally in order to obtain pieces of dough (1) of given length (y),
—g— fermenting the pieces of dough,
—h— baking the pieces of dough,
—i— optionally, cooling down the baked bread,
—j— optionally, packaging the cooled baked bread.

8. The method according to claim 7, characterized in that flour is used as anti-adhesion agent,
in that the strips of dough are floured before the step —d— of providing recessed marks, preferably during steps —b— and —c—,
and in that the optional step —e— consists in particular of brushing the strips of dough.

9. The method according to claim 7, wherein the step —c— of transforming the dough into strips of dough comprises sub-steps of extrusion —c1—, sheeting —c2— and longitudinal cutting —c3—.

10. The method according to claim 7, wherein the baking in step —h— is partial so as to obtain pre-baked breads.

11. The method according to claim 7, wherein the baking in step —h— is carried out in steam-saturated atmosphere.

12. The method according to claim 7, wherein for the packaging in step —j—, the cooled breads are arranged in packaging containers which are then sealed.
